(19) United States
(12) Patent Application Publication
(10) Pub. No.: US 2014/0093248 A1
(43) Pub. Date: Apr. 3, 2014

(54) REMOTE CONTROL SYSTEM AND POWER SUPPLY CONNECTOR REMOTE CONTROL DEVICE

(71) Applicant: Quanta Computer Inc., Taoyuan Shien (TW)

(72) Inventors: Chao-Kang CHIANG, New Taipei City (TW); Yu-Hsin Lin, Taipei City (TW)

(73) Assignee: Quanta Computer Inc., Taoyuan Shien (TW)

(21) Appl. No.: 13/900,818

(22) Filed: May 23, 2013

(30) Foreign Application Priority Data
Oct. 1, 2012 (TW) 101136245

(51) Int. Cl. G08C 23/04

(52) U.S. Cl. CPC G08C 23/04
USPC 398/106

(57) ABSTRACT

A power supply connector remote control device is provided. The power supply connector remote control device comprises a network signal-receiving module, an infrared transmission module and a power-converting module. The network signal-receiving module receives a control signal from a first network. The infrared transmission module transmits an infrared control signal to a corresponding electronic device according to the control signal to control the corresponding electronic device. The power-converting module is electrically connected to a power socket to provide power to the network signal-receiving module and the infrared transmission module.

### RELATED APPLICATIONS

This application claims priority to Taiwan application no. 101136245, filed Oct. 1, 2012, the entirety of which is incorporated herein by reference.

### BACKGROUND

1. Technical Field

The present disclosure relates to a remote control technology. More particularly, the present disclosure relates to a remote control system and a power supply connector remote control device.

2. Description of Related Art

Due to the progress of the technology, most of the families are equipped with various home appliances having the remote control ability, especially the multimedia electronic devices such as televisions, audio playback devices, video playback devices or amplifiers. Each of the electronic devices has its own corresponding remote controller such that the remote controller can turn on, turn off or adjusts the operation mode of a specific device. The number of the remote controllers increases with more and more home appliances presented. When there are too many remote controllers, the user may take the wrong remote controller easily or may not find the correct remote controller. Universal remote controller is thus designed to solve the problems mentioned above. The object of the use of the universal remote controller is to control most of the home appliances with only one controller. However, the design of the current universal remote controller is still not convenient and practical enough.

One of the main and obvious disadvantages is that the current infrared remote controller can not perform the remote control mechanism when the user is not at home. For example, the user, not at home, can't set up the video recorder to record the television program that is playing currently, or the user can't to turn on the air conditioner before arriving home, even the user who stays on the first floor can't to control the devices located on the second floor.

Accordingly, what is needed is a remote control system and a power supply connector remote control device to overcome the power and the remote control issues described above.

### SUMMARY

An aspect of the present invention is to provide a power supply connector remote control device. The power supply connector remote control device comprises a network signal-receiving module, an infrared transmission module and a power-converting module. The network signal-receiving module receives a control signal from a first network, wherein the control signal is generated from a remote control device. The infrared transmission module transmits an infrared control signal to a corresponding electronic device according to the control signal to control the corresponding electronic device. The power-converting module is electrically connected to a power socket to provide power to the network signal-receiving module and the infrared transmission module.

Another aspect of the present invention is to provide a remote control system. The remote control system comprises a remote control device, a network module and a power supply connector remote control device. The remote control device generates a control signal. The network module receives the control signal from a first network and generates a second network. The power supply connector remote control device comprises a network signal-receiving module, an infrared transmission module and a power-converting module. The network signal-receiving module receives control signal from the second network. The infrared transmission module transmits an infrared control signal to a corresponding electronic device according to the control signal to control the corresponding electronic device. The power-converting module is electrically connected to a power socket to provide power to the network signal-receiving module and the infrared transmission module.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a diagram of a remote control system in an embodiment of the present invention;

FIG. 2 is a block diagram of the power supply connector remote control device in an embodiment of the present invention; and

FIG. 3 is a block diagram of the power supply connector remote control device and the network module in another embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

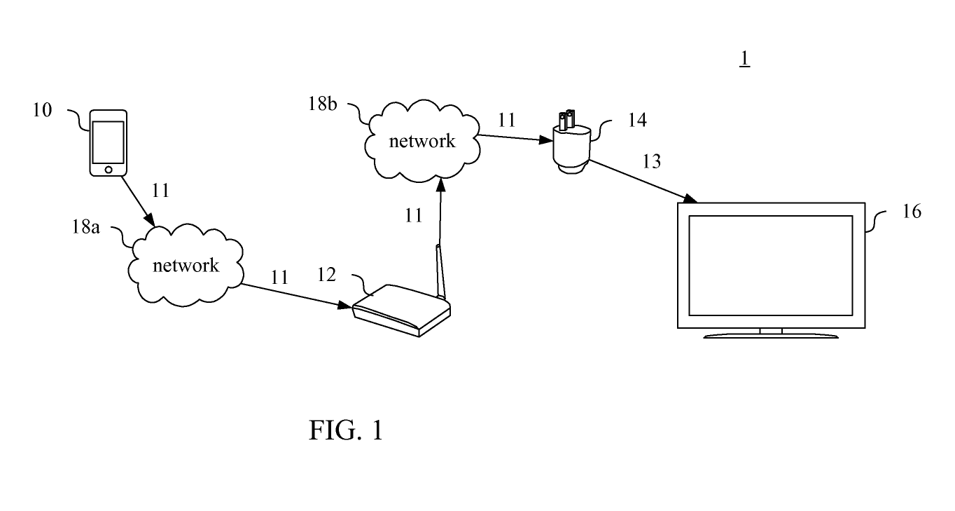

FIG. 1 is a diagram of a remote control system 1 in an embodiment of the present invention. The remote control system 1 comprises a remote control device 10, a network module 12 and a power supply connector remote control device 14.

The remote control device 10 generates a control signal 11. In an embodiment, the remote control device 10 is a handheld electronic device, e.g. a Smartphone or a tablet PC that is able to connect to a network 18a. In another embodiment, the remote control device 10 is a notebook PC or a desktop that is able to connect to the network 18a. In yet another embodiment, the remote control device 10 is a remote controller that is able to connect to the network 18a. The remote control device 10 can store a set of the control commands in advance, in which the set of the control commands is corresponding to the electronic devices that the user would like to operate such that the electronic devices can be operated accordingly. In a substantial embodiment, the set of the control commands is a table of press keys corresponding specific electronic devices and control commands. For example, if the user presses a certain key of the remote control device 10, the remote control device 10 can generate the information of the corresponding electronic device and control command (e.g. television and power-on) according to the table, convert the control command to a control signal 11 and transmit the control signal 11 through the network 18a.

The remote control device 10 can connect to the network 18a through a wired form such as optical fibers or the telephone network, and transmit the control signal 11. In other embodiments, the remote control device 10 can connect to the network 18a through a wireless form such as mobile communication system (e.g. 3G or 4G) or the wireless technology of WiFi.

The network module 12 receives the control signal 11 from the network 18a. In the present embodiment, the network module 12 can use, for example, an ADSL network to connect the network 18a through a wired form (e.g. optical fiber or telephone network) or a wireless form (e.g. mobile communication system or WiFi), and then transmit the received the control signal 11 through a network 18b. In a substantial embodiment, the network module 12 can establish the network 18b by using a built-in or an external wireless base station, a wireless transmission module or a wireless router.

In the present embodiment, the power supply connector remote control device 14 is a power plug that can be plugged into a power socket (not shown). In the present embodiment, the power supply connector remote control device 14 can connect to the wireless network 18b through wired or wireless form to receive the control signal 11 from the network module 12. The power supply connector remote control device 14 further generates an infrared control signal 13 according to the control signal 11.

After an electronic device 16 corresponding to the infrared control signal 13 receives the infrared control signal 13, the corresponding electronic device 16 operates according to the infrared control signal 13. For example, the infrared control signal 13 can either turn on or turn off the corresponding electronic device 16, adjust the parameters (e.g. volume or channel) of the corresponding electronic device 16 or modify the operation mode of the corresponding electronic device 16. The detail description of the operation of the power supply connector remote control device 14 is shown in the subsequent paragraphs.

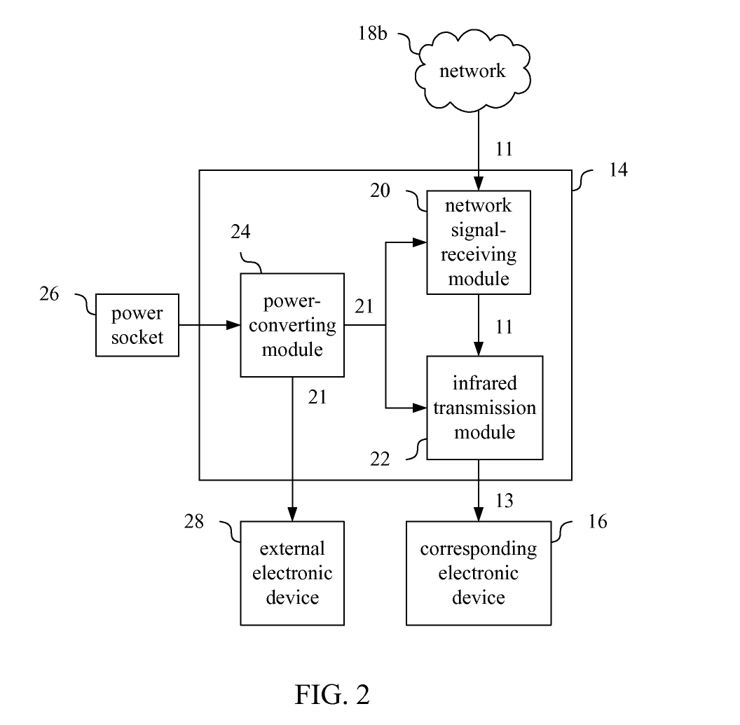

FIG. 2 is a block diagram of the power supply connector remote control device 14 in an embodiment of the present invention. The power supply connector remote control device 14 comprises a network signal-receiving module 20, an infrared transmission module 22 and a power-converting module 24.

The network signal-receiving module 20 receives the control signal 11 from the network 18b. In the present embodiment, the network 18b that allows the network module 12 and the network signal-receiving module 20 communicating with each other is WiFi network. In other embodiments, the network 18b can be Bluetooth or other types of wireless networks, depending on different applications.

The infrared transmission module 22 transmits the infrared control signal 13 to the corresponding electronic device 16 according to the control signal 11 to control the electronic device 16. Since the infrared control signal 13 generated by the infrared transmission module 22 is directional, if the infrared transmission module 22 is disposed inside the power supply connector remote control device 14, the power supply connector remote control device 14 can be located at a place that the corresponding electronic device 16 is able to receive the infrared control signal 13. In another embodiment, the infrared transmission module 22 is disposed outside of the power supply connector remote control device 14 and is connected to the network signal-receiving module 20 through a transmission wire (not shown). In such as case, only the infrared transmission module 22 needs to be located at the place that the corresponding electronic device 16 is able to receive the infrared control signal 13.

The power-converting module 24 is electrically connected to the power socket 26 to perform a power-conversion mechanism to generate the power 21 that can be used by the network signal-receiving module 20 and the infrared transmission module 22. After the conversion, the power-converting module 24 further transmits the power 21 to the network signal-receiving module 20 and the infrared transmission module 22.

Since the power-converting module 24 is a power plug for converting and transmitting power, it can further provide the power 21 to an external electronic device 28. In an embodiment, the external electronic device 28 can be the corresponding electronic device 16 that is supposed to be controlled by the power supply connector remote control device 14. In another embodiment, the power supply connector remote control device 14 can be the power plug for both of the corresponding electronic device 16 and the external electronic device 28. In a substantial embodiment, the corresponding electronic device 16 can be a television and the external electronic device 28 can be an air conditioner.

Accordingly, the power supply connector remote control device 14 of the remote control system 1 can directly connect to the power socket to provide power to the network signal-receiving module 20 and the infrared transmission module 22. The power supply connector remote control device 14 can further control electronic devices and provide a power-converting mechanism at the same time.

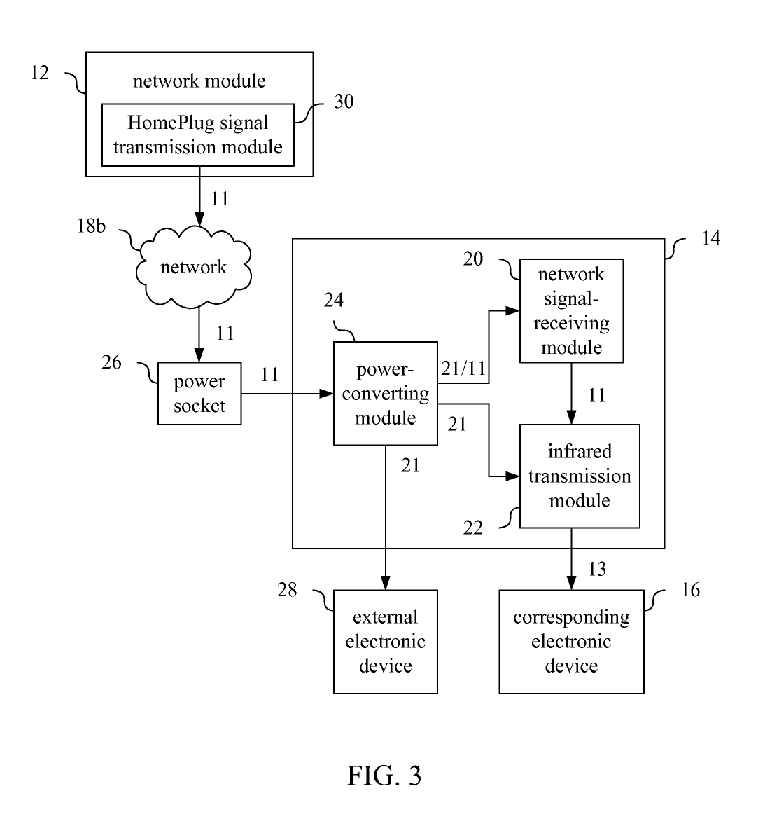

FIG. 3 is a block diagram of the power supply connector remote control device 14 and the network module 12 in another embodiment of the present invention. Similar to the power supply connector remote control device 14 depicted in FIG. 2, the power supply connector remote control device 14 shown in FIG. 3 comprises the network signal-receiving module 20, the infrared transmission module 22 and the power-converting module 24.

In the present embodiment, the network 18b is a wired network. For example, the network module 12 may comprise a HomePlug signal transmission module 30 or a power line communication module, and the network signal-receiving module 20 is a corresponding HomePlug signal-receiving module. HomePlug technology is a power line communication standard interface and is able to connect multiple electronic devices through the power line. The HomePlug technology can support the devices having the communication interfaces of Ethernet, USB and WiFi (wireless network). Once the devices equipped with the HomePlug technology is plugged into the power socket, the devices can connect to the network.

Hence, the network module 12 can transmit the control signal 11 to the power line network through the HomePlug signal transmission module 30 such that the network signal-receiving module 20 can receive the control signal 11 from the power socket 26. The network signal-receiving module 20 further extracts and transmits the control signal 11 from the power-converting module 24 to the infrared transmission module 22 such that the infrared transmission module 22 delivers the infrared control signal 13 accordingly.

The power supply connector remote control device 14 can use the wired network such as the power line network to receive the control signal 11. Since the power supply connector remote control device 14 itself is a power plug, it is efficient to use the power line network to receive the control signal 11.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power supply connector remote control device comprising:
a network signal-receiving module to receive a control signal from a first network, wherein the control signal is generated from a remote control device;
an infrared transmission module to transmit an infrared control signal to a corresponding electronic device according to the control signal to control the corresponding electronic device; and
a power-converting module electrically connected to a power socket to provide power to the network signal-receiving module and the infrared transmission module.

2. The power supply connector remote control device of claim 1, wherein the first network is a WiFi or a Bluetooth wireless network.

3. The power supply connector remote control device of claim 1, wherein the network signal-receiving module is a HomePlug signal-receiving module to receive the control signal from the power-converting module through the power socket.

4. The power supply connector remote control device of claim 1, wherein the infrared transmission module is electrically connected to the network signal-receiving module through a transmission wire.

5. A remote control system comprising:
a remote control device to generate a control signal;
a network module to receive the control signal from a first network and generate a second network; and
a power supply connector remote control device comprising:
a network signal-receiving module to receive a control signal from the second network;
an infrared transmission module to transmit an infrared control signal to a corresponding electronic device according to the control signal to control the corresponding electronic device; and
a power-converting module electrically connected to a power socket to provide power to the network signal-receiving module and the infrared transmission module.

6. The remote control system of claim 5, wherein the first network is a mobile communication system.

7. The remote control system of claim 6, wherein the network module further comprises a wireless transmission module to generate the second network.

8. The remote control system of claim 5, wherein the network module further comprises a wireless transmission module to generate the second network.

9. The remote control system of claim 5, wherein the network module is a HomePlug signal transmission module to generate the second network; the network signal-receiving module is a HomePlug signal-receiving module to receive the control signal from the power-converting module through the power socket.

10. The remote control system of claim 5, wherein the infrared transmission module is electrically connected to the network signal-receiving module through a transmission wire.
